(19) United States
(12) Patent Application Publication
(10) Pub. No.: US 2009/0307237 A1
(43) Pub. Date: Dec. 10, 2009

(54) RATING SYSTEM THAT CHARACTERIZES ATTORNEYS BASED ON ATTRIBUTES

(76) Inventors: Mark Britton, Seattle, WA (US); Justin Chan, Bellevue, WA (US); Sendi Widjaja, Bellevue, WA (US)

Correspondence Address: PERKINS COIE LLP;PATENT-SEA, P.O. BOX 1247, SEATTLE, WA, 98111-1247, US

(21) Appl. No.: 12/134,123

(22) Filed: Jun. 5, 2008

(51) Int. Cl. G06F 17/30

(52) U.S. Cl. 707/100; 707/E17.009

(57) ABSTRACT

A hardware and/or software system for calculating attorney ratings. Data associated with an attorney is collected from a variety of sources. The collected data includes information that can be used to assess how well an attorney might handle legal issues. The data is used to determine values of one or more attributes associated with the attorney. One or more ratings may be calculated for the attorney based on the determined attributes. Each rating may be based on a weighted combination of two or more attributes. The ratings may be converted to a format that is more comprehensible to a consumer and presented to consumers of legal services in a variety of different forms. An unbiased assessment of attorneys in the form of a rating enables consumers of legal services to make more accurate and informed decisions when selecting an attorney.

### CROSS-REFERENCE TO RELATED APPLICATION(S)

This application claims the benefit of U.S. Provisional Application No. 61/942,182 entitled RATING SYSTEM THAT CHARACTERIZES ATTORNEYS BASED ON ATTRIBUTES, filed Jun. 5, 2007.

### BACKGROUND

Selecting an attorney to assist with a legal problem can be a challenging process. People in need of an attorney may ask family, friends, or work colleagues when looking for a recommendation. They may search the Yellow Pages, call the bar association, or visit any of a number of websites that provide information about attorneys or firms. Even attorneys have a difficult time finding other counsel to assist with problems, and typically rely on the recommendations of other attorneys. One of the challenges in identifying an attorney to assist with a legal problem is a lack of objective evidence that may be used to assess the quality of the potential counsel. Other than word of mouth, there is no reliable source that assembles information that might be relevant to choosing an attorney and packages the information into a form that makes it easy to assess the attorney. It would therefore be beneficial for consumers of legal services if such a source of attorney information existed.

### BRIEF DESCRIPTION OF THE DRAWINGS

FIG. 1 depicts an environment in which an attorney rating system may operate.

FIG. 2 depicts a table containing various attributes that may be compiled about an attorney from different sources of data.

FIG. 3 is a screen shot of a representative interface that depicts a presentation of an attorney rating to consumers.

FIG. 4 is a flow diagram of a process to enable a user to define a new attorney rating.

FIG. 5 is a flow diagram of a process for calculating an attorney score in order to establish an attorney rating.

### DETAILED DESCRIPTION

A hardware and/or software rating system is disclosed for calculating one or more ratings for an attorney. Data associated with an attorney is collected from a variety of public and private sources, such as state bar associations, court records, attorney websites, and information attorneys provide to the rating system. The collected data includes any information that can be used to assess how well an attorney might handle legal issues, such as the work experience of the attorney, professional recognition of the attorney, and the character of the attorney. The data is used to determine values of one or more attributes associated with the attorney. One or more ratings may be calculated for the attorney based on the determined attributes. Each rating may be based on a weighted combination of two or more attributes. For example, an experience rating for an attorney may be based 75% on years of experience and 25% on awards the attorney has received, while an industry recognition rating may be based 90% on peer endorsements and 10% on awards. As another example, an overall rating may be based on a combination of all of the available attributes. The ratings may be converted to a format that is more comprehensible to a user, such as a scale from 1-10, a grade from A-F, an ordinal ranking, a percentile ranking, and so on. The ratings may be presented to consumers of legal services in a variety of different forms. For example, ratings for an attorney may be displayed to users on a webpage maintained by the rating system or on a webpage maintained by the attorney. An attorney may use the rating as a badge on her website to promote her legal services and/or her abilities as an attorney. By providing an unbiased assessment of each attorney in the form of a rating, consumers of legal services are able to make more accurate and informed decisions when selecting an attorney to assist with a legal problem.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

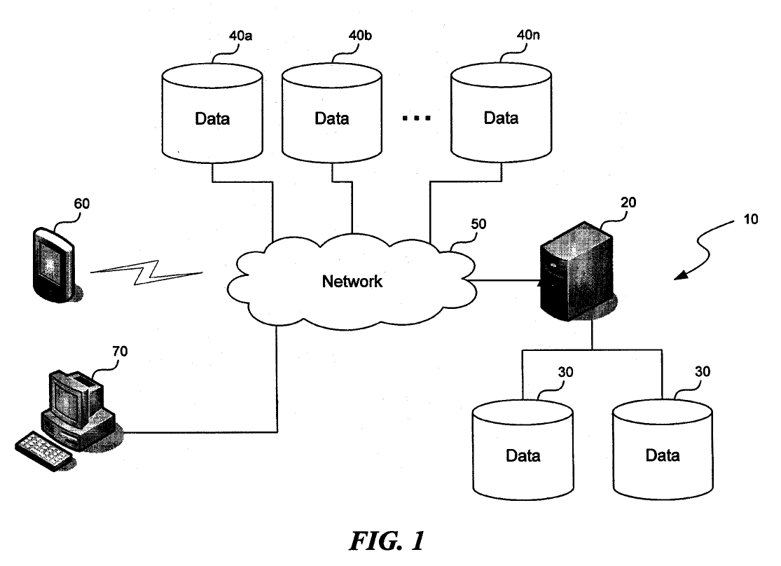

FIG. 1 depicts an environment in which the attorney rating system 10 may operate. The rating system 10 comprises one or more servers 20 connected to one or more integral or remote data storage areas 30 (such data storage areas contained in memory or other storage medium such as a hard drive, optical drive, etc.). The server contains one or more processors to access computer programs, procedures, and data that are stored in the data storage areas, and execute the instructions contained within the stored programs and procedures. Attorneys that are rated by the system are rated using data that is derived from a variety of data sources 40a, 40b, . . . 40n. Data sources 40a, 40b, . . . 40n may be public databases, such as attorney discipline records maintained by state bar associations, published decisions by state and federal courts, court records maintained in different jurisdictions, criminal databases maintained by law enforcement agencies, websites of law firms or solo practitioners, and any other publicly accessible records pertaining to attorneys. The data sources 40a, 40b, . . . 40n may also be private databases, such as proprietary databases maintained by state bar associations or private information services that typically require fees to be paid in order to access data. The data sources may be accessed through public or private networks 50, such as the Internet. Data may also be directly provided to the rating system by users of the system. As will be described in additional detail herein, the rating system 10 analyzes data from the data sources in order to determine various attributes associated with each attorney. Based on the attributes, ratings are calculated for each, attorney and published to consumers of legal services or services that utilize the ratings. The ratings may be published via a publicly or privately accessible interface, such as via a website or via an API. The published ratings allow consumers of legal services to make informed choices when retaining an attorney to provide legal services. The consumers may access the attorney rating system 10 via portable devices 60, via computers 70, or via any other device that can provide an interface to the attorney rating system data. The rating data may be directly served from the attorney rating system 10, or the data may be served to a third-party service that uses the data to provide a product or service to consumers. Those skilled in the art will appreciate that consumers of legal services may span a broad range of potential groups, from individuals seeking to hire an attorney to help them with a will, to corporate attorneys seeking outside counsel to advise them on complex security matters, to government employees wishing to learn more about attorneys that are negotiating for or against the government. There is no limit to the range of potential users of the attorney rating system once the system becomes available.

An attorney's rating or ratings are based on data received from the various data sources 40a, 40b, . . . 40n. The data may be pushed by the data sources to the rating system, or the data may be pulled from the data sources (e.g., via calls to an API or scraping of a website). Data may also be contributed to the rating system by consumers of legal services such as clients or other attorneys. Data from external data sources may be received on a periodic basis or on a continuous basis. As new data sources become available, the new data sources may be integrated into the ratings that are calculated by the rating system. As old data sources are discontinued or become unreliable, they may be removed from the calculation of the ratings by the rating system.

The data that is obtained by the rating system may be any data that is relevant to the quality of legal services offered by the attorney or the character of the attorney. Such data typically falls into three categories: the work experience of the attorney, the professional recognition of the attorney, and the character of the attorney. The work experience of the attorney may include certain factual details about the attorney, such as the number of years that the attorney has been practicing law and the length and type of positions in which the attorney has been employed in his/her career. The professional recognition of the attorney may include information about other parties recognizing the expertise or character of the attorney, such as awards that the attorney may have received and endorsements that were made by peers. The character of the attorney may include the criminal record of the attorney or any actions, sanctions, admonishments, or disbarment of the attorney by bar associations. Those skilled in the art will appreciate that numerous other pieces of data relevant to the quality or character of the attorney may fall into these or other categories.

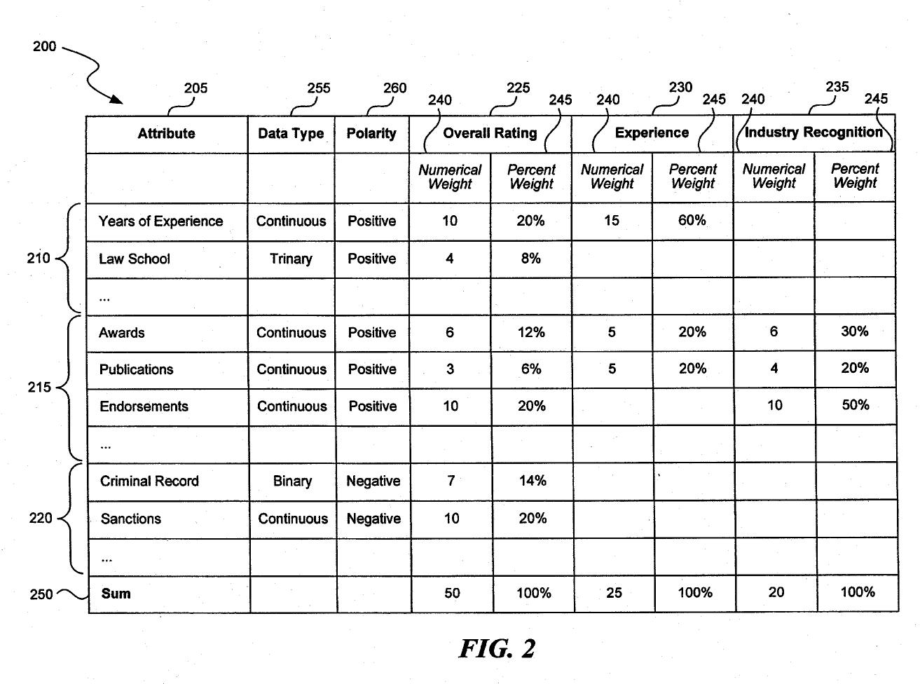

Once data from various sources is collected by the rating system 10, the data is analyzed and reconciled to determine various attributes that are associated with an attorney. FIG. 2 depicts a table 200 showing the various attributes that may be compiled about an attorney from the collected data. One skilled in the art will appreciate that while FIG. 2 provides an illustration that is easily comprehensible by a human reader, the actual information may be stored using different data structures and data organizations. The first column 205 lists the various attributes that may be associated with an attorney. The first set of rows 210 in the table pertain to the work experience of the attorney, the second set of rows 215 pertain to the professional recognition of the attorney, and the third set of rows 220 pertain to the character of the attorney. It will be appreciated that a greater or lesser number of attributes may be added to the table and used to construct attorney ratings. Each attribute may be assigned a numerical value on the basis of an algorithm or look-up table. For example, attorneys having five or more awards may achieve a value of “100” for the awards attribute, whereas attorneys with three awards may achieve a value of “50,” and attorneys with one award may achieve a value of “25.” As another example, each individual award may be assigned a numerical value on the basis of an algorithm or look-up table and used to compute a composite value for the awards attribute. For example, awards that are considered to have higher prestige may receive 40 points while less prestigious awards receive 10 points. A value of the awards attribute for an attorney may be computed as the sum of the values of the awards the attorney has received. A mapping of each award, or “element” of the awards attribute, to a value assigned to the award may be stored in table 200 or in a separate table. The columns of the table represent how the attributes are used to calculate different ratings that are maintained by the system. The first rating 225 is an overall rating, pertaining to the overall quality of the attorney, the second rating 230 is an experience rating, pertaining primarily to the experience level of the attorney, and the third rating 235 is an industry recognition rating, pertaining to the accolades the attorney has received. Other ratings could be calculated and maintained by the system if desired.

The rating for an attorney is calculated based on one or more attributes. A first column 240 of each rating in the table represents a numerical weight that is associated with each attribute in the calculation of that rating. A second column 245 represents a percentage weight that is associated with each attribute in the calculation of that rating. For example, in the overall rating 225 in FIG. 2, each of the attributes is used to calculate the overall rating. Attributes having a higher weighting (such as years of experience or sanctions, which have a weighting of “10”) have a greater impact on the overall rating, while attributes having a lower weighting (such as awards or law school, having a weighting of “6” and “4” respectively) have a lower impact on the overall rating. The numerical weighting system is an open ended system, allowing each attribute to have any numerical value assigned to it. The sum row 250 at the bottom of the table indicates the sum of all the weights. The sum of the weights is used in the denominator in order to calculate the percentage that each attribute should contribute to the rating score. For example, since years of experience has a 10 weighting and the sum of the numerical weights is 47, the years of experience attribute accounts for 21% of the overall rating score of the attorney as reflected in the percentage weighting column 245. To calculate the overall score for an attorney a value associated with each attribute is summed, with each value weighted in accordance with the amount indicated in the percentage weighting column. As indicated in a data type column 255, each attribute can take on a binary, trinary, continuous, discrete, or other value. The values associated with each attribute are preferably normalized to make every attribute roughly worth the same prior to the weighting. As indicated in a polarity column 260, each attribute value may also take on either a positive or negative value. Positive values (like experience) contribute to the rating whereas negative values (like sanctions) detract from the rating. By summing the weighted values for each attribute, a raw score may be calculated for each rating. For some attributes, a raw score may be calculated by adding negative values to a base score. For example, each attorney may initially receive a professional conduct base score of 100, which is reduced for every sanction an attorney receives based on the type and extent of the sanction imposed. The raw rating scores may be provided to consumers or other services in order to assist the recipients in selecting or retaining counsel.

In some embodiments, the attribute data type may be taken into account when calculating the percentage weight from the numerical weight. For example, under the calculation described above, binary attributes may have a greater than desired impact on a rating since there is an all-or-nothing value associated with the attribute. In contrast, a continuous attribute may have a smaller than desired impact on a rating since the value of the attribute may only vary within a small range for most of the population of attorneys. In order to prevent binary or other similar types of attributes from driving the rating score, the actual percentage weights associated with binary attributes may be reduced to a smaller value than would otherwise be expected under the previously described calculation. For example, in FIG. 2 the percentage weight of the criminal record may be reduced to less than 15% in order to account for the binary nature of the attribute. The percentage weights associated with the other attributes may be correspondingly increased to account for the reduction.

In some embodiments, the percent weight for an attribute may be fixed for a particular rating. Once the percent weight is set, the system can calculate a numerical weight for the attribute based on the weights of other attributes associated with the rating. For example, in FIG. 2, a percent weight of 20% could be assigned to a new attribute associated with the Industry Recognition rating. The attorney rating system would calculate a numerical weight of 4 for the new attribute and adjust the percent weights of the Awards and Endorsements attributes to 30% and 50%, respectively. In this manner, one can ensure that an attribute has no more influence on a rating than intended, regardless of how other attributes are later configured.

In some embodiments, it may be beneficial to convert the raw rating score into a more readily understood number. For example, people are generally very comfortable with a 10 point scale, with 10 being a perfect score and 1 being a very poor score. The raw rating score may therefore be scaled so that the rating for an attorney falls within a 1-10 scale. Also, because it is nearly impossible to achieve perfection in each attribute, the raw rating score may also be mapped to a bell curve or other statistical model that more closely approximates the range of scores associated with the attorney population. For example, if the maximum theoretical raw rating score is 1000, but no attorney scores more than 755 on the raw score, then 755 may be assigned a perfect score of “10” and all other scores may be mapped downward from that score.

In some embodiments, the value assigned to each attribute or attribute element may change over time. For example, the value of awards to an attorney may decrease the farther back in time the award was received. Awards received more than ten years ago may count a minimum amount, whereas awards received in the past two years may count significantly. The decay rate for a value assigned to an attribute or attribute element may remain constant over time or vary with time. For example, the value associated with a particular award may decay linearly, exponentially, logarithmically, etc. The algorithm or look-up table used to assign a value to the attribute may be adjusted to take into account such temporal issues. The value of attributes may also reach a minimum value after a certain period of time, beyond which the value will not decay further.

Values assigned to each attribute or attribute element also may increase over time as additional information about the attribute or attribute element is collected. For example, if there is insufficient data to determine when an attorney received an award, the rating system may assume that the attorney received the award at the time the attorney was admitted to practice and assign a value accordingly. An award received by an attorney admitted to practice 25 years ago may therefore receive zero points if the date on which the award was won is unavailable and the decay function for the award reduces the value assigned to the award to zero within 25 years of receiving the award. When the rating system subsequently receives the award date for the award, the assigned value may increase if the decay period for the award is incomplete, for example, if the attorney received the award only a year ago. Conversely, sanctions may be assumed to have been imposed at the latest possible date (i.e., the time at which a value is assigned or a rating calculated). The assumptions made when complete information is unavailable tend to encourage attorneys to disclose information by not decreasing a rating value as new information is obtained. As another example of how a value assigned to an attribute or attribute element may increase, the value of an article published by an attorney may increase as other articles or judicial opinions cite the article. Similarly, the value for an award may increase if there is found to be a strong positive correlation between receiving the award and an attorney rating.

In some embodiments, the number of attribute elements considered in computing a value for an attribute may be capped. For example, the awards attribute may be based on no more than five awards, regardless of the number of awards an attorney has won. The rating system may employ different capping techniques for different attributes, such as time-based capping or value-based capping. Time-based capping involves considering only the most recent elements when calculating a value for an attribute. For example, the value computed for the Awards attribute may be based on the last five awards an attorney has won. Value-based capping involves considering only the most valuable elements when calculating a value for an attribute. For example, the value computed for the Endorsements attribute may be based on the endorsements of the five highest-rated peers that have endorsed the attorney. It will be appreciated that the cap size and capping technique for a particular attribute may be adjusted over time. For example, attorneys have a greater number of years of experience may be capped at a larger number of attribute elements, whereas attorneys having a lesser number of years of experience may be capped at a smaller number of attribute elements.

Various attributes may be used to calculate different types of ratings for each attorney. For example, the overall rating 225 uses all of the attributes to calculate the rating of an attorney. In contrast, the experience rating 230 only uses two of the attributes, namely the number of years of experience and the awards received by the attorney. The operator of the rating system or others relying on data delivered by the rating system may select any combination of the attributes that are monitored by the system and combine the attributes in any combination, using any algorithm, with any number of elements, and with any weighting in order to produce a particular rating. The ability to combine attributes in any combination provides significant flexibility when crafting ratings for different applications.

It will be appreciated that it may be difficult to achieve perfect data about an attorney. For example, available data sources about an attorney may be incomplete or missing. Furthermore, some attributes may rely on data sources that provide little if any information for certain types of attorneys. For example, court records may provide little information for transactional attorneys. As a result, only some of the attributes about an attorney may be populated. When data about certain attributes is missing, the rating system may choose to ignore that attribute in the rating calculation and assign that particular attribute a value of zero. Alternatively, the system may elect to assign an average or nominal rating to the missing attribute so that the attorney is not penalized for missing data. If a minimal amount of data is available for an attorney, the system may elect to not rate the attorney until a sufficient amount of data has been received about that attorney. Alternatively, the system may rate attorneys for whom there is limited data according to a binary rating system indicating whether there is some reason to pay attention to the attorney. For example, if the data available for an attorney indicates that the attorney has faced a disciplinary action with no positive data, the rating system may assign a rating of “Attention.” Alternatively, if there is limited data for an attorney and no reason to assign a rating of “Attention,” the rating system may assign a rating of “No Concern.” The lack of a numeric or substantive rating will often stimulate an attorney to ensure that sufficient data is delivered to the rating system to produce the rating. The ratings may be modified as additional or better data becomes available.

The ratings of attorneys maintained by the rating system may be calculated periodically (e.g., once a month, twice a year, when new data is received), on a continuous basis, or any combination thereof (e.g., continuously for new attorneys and quarterly for those attorneys that have been practicing for more than 10 years). If changes are made to the manner in which a particular rating is calculated, the ratings that result from those changes may be phased in over time so that attorneys will not see a step-function in the ratings (e.g., so that an attorney doesn't see their rating drop from a “9.0” to an “8.5” overnight). Instead, the new ratings may be phased in over a period of six months to a year to ensure that the change will be gradual. If a rating changes based on new data that is received, the change to the rating may be made immediately or it may be phased-in over time. Allowing the rating to change immediately provides a benefit in that it encourages attorneys to update their data since they see immediate results from the update.

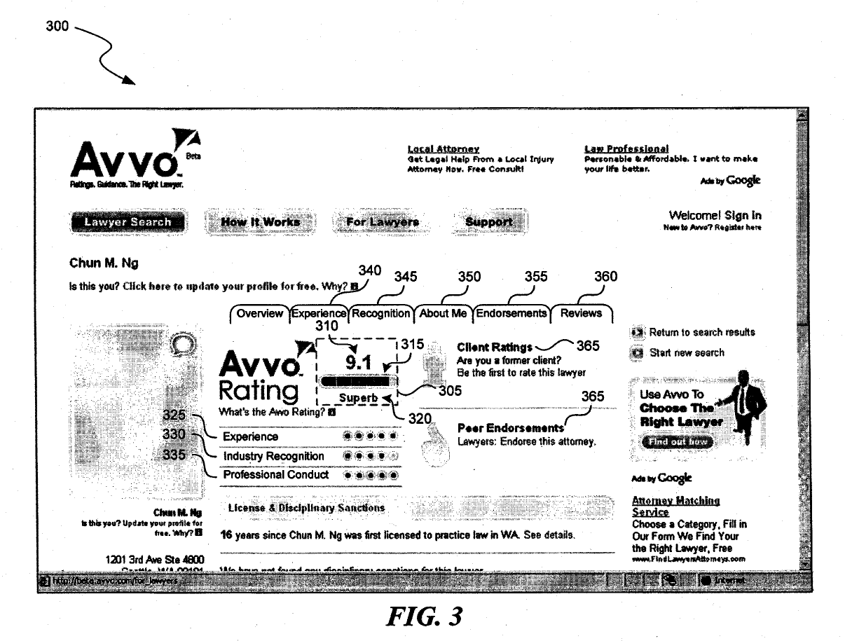

Once one or more ratings have been calculated for an attorney, the ratings may be displayed to consumers of legal services in a variety of ways. FIG. 3 is a screen shot of a representative interface 300 that depicts one way that ratings may be presented to consumers. Four ratings are depicted in the interface. The first and most prominent is the overall rating 305, represented in the interface using a 10-point scale. The overall rating is presented to consumers as a number 310, as a graphical bar 315, and as a text label 320. Since different consumers respond to interfaces in different ways, reinforcing the overall rating by representing the rating in different forms is beneficial. In addition to an overall rating, other ratings may be presented about an attorney. The other ratings may be focused on particular aspects of an attorney that consumers of legal services may find helpful when selecting an attorney. For example, three additional ratings are shown in the depicted interface: an experience rating 325, an industry recognition rating 330, and a professional conduct rating 335. Each of these secondary ratings are presented to the consumer in a five-point graphical scale. Those skilled in the art will appreciate that other graphical treatments may be used to present the ratings, such as stars, color-coding, etc.

In some embodiments, consumers of legal services are allowed to adjust the weight or value that is assigned to at least one of the attributes or attribute elements in order to change the relative importance of that attribute or attribute element to a rating score. For example, if a consumer considers the years of experience to be the most important attribute when selecting counsel, the consumer can increase the weight of that attribute in the rating process and receive a rating of counsel that is skewed towards years of practice. As another example, if a consumer does not consider the law school that an attorney attended to be relevant to their selection, the consumer may decrease the weight of the law school attribute in the rating process and receive a rating of counsel that does not depend on the law school attended. Similarly, if a consumer considers articles published in journals that are not peer-reviewed to be unimportant, the consumer may adjust the value assigned to these articles accordingly. To facilitate the adjustment of values, the rating system may categorize attribute elements allowing a consumer to quickly sort and select attribute elements that should or should not be considered when calculating a value for an attribute.

In addition to presenting the rating of an attorney, other information that may be helpful to assessing an attorney is provided in the interface 300. Various tabs may be accessed by consumers to see some or all of the data used to determine the attributes of the attorney. For example, an experience tab 340 may be selected to see data that might be used to assess the attorney's experience. A recognition tab 345 may be selected to see the data associated with awards, publications, and other public recognition of the attorney. A client ratings tab 350 may be selected to see comments that were submitted by clients that have used the attorney. A peer endorsement tab 355 may be selected to see comments that been submitted by attorneys that know or have worked with the attorney. A review tab 360 may be selected to see comments and ratings contributed by an attorney's clients or those who have worked with the attorney. Various links 365 are provided to allow clients and peers to submit comments about the particular attorney. Other information may also be presented to consumers, such as a picture of the attorney, firm affiliation, contact information, etc. By providing such a complete picture of an attorney in one place, consumers of legal services are able to quickly find the attorney that is best suited to help with their legal problem.

Rating information may also be displayed to consumers as a “badge” on other websites. The badge may provide an indication of an attorney rating and a link to a profile for the attorney maintained by the rating system. For example, an attorney may place a badge on her personal website or on the website maintained by her law firm as an indication of the quality of her legal services. Clicking on the badge may direct the consumer to a webpage maintained by the rating system where the consumer can browse information about the attorney and the attorney's ratings. The badge may display a single rating for the attorney or a more comprehensive list of ratings. In some cases, an attorney may be permitted to customize a badge by configuring various physical attributes of the badge (e.g., size, shape, color, font, etc.) and which ratings are included with the badge (e.g., overall rating, experience rating, etc.). Badges may also include other information maintained by the rating system, such as an indication of awards an attorney has received or names and links to profile pages of those who have endorsed the attorney. In addition to advertising the qualities of an attorney, badges have the effect of advertising the rating system and directing consumers to the rating system through the associated links. Furthermore, the rating system can track the number of times that an attorney's badge is viewed and use this information in rating the attorney.

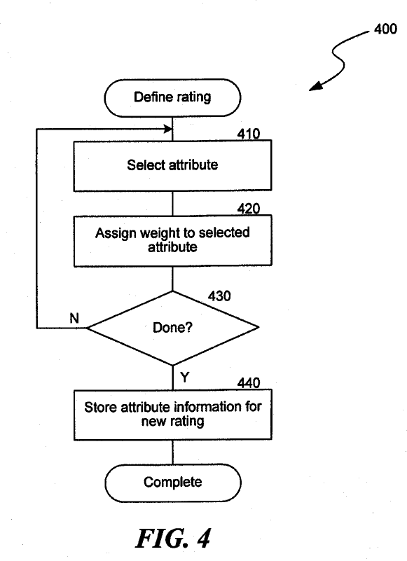

FIG. 4 is a flow diagram of a process 400 to enable a user to define an attorney rating. The process is performed by a user to create a new rating for the rating system. In block 410, the user selects an attribute to be associated with the new rating. In block 420, the user assigns a weight to the selected attribute. The weight represents the attribute's influence on a particular rating—the higher the rating compared to other attributes, the greater the influence that the attribute will have on the rating. The rating system permits the user to assign a numeric or percent weight to an attribute. When a user assigns a numeric weight for an attribute, the influence the attribute has on a rating may change depending on the weights assigned to other attributes. When a user assigns a percent weight to an attribute, the influence the attribute has on a rating remains fixed, regardless of the weights assigned to other attributes. Once a user assigns a numeric weight to an attribute, the system can automatically calculate a value for the percent weight based on the weights of the other attributes and vice versa. In decision block 430, if the user has not completed defining the rating, the process loops to block 410 so that the user can select another attribute and assign a weight to that attribute, else the process continues to block 440. In block 440, the process stores the attribute information configured by the user in, for example, a table similar to table 200 in FIG. 2. In some cases, the user may receive a warning message if the sum of the percent weights does not equal 100%. The process then completes.

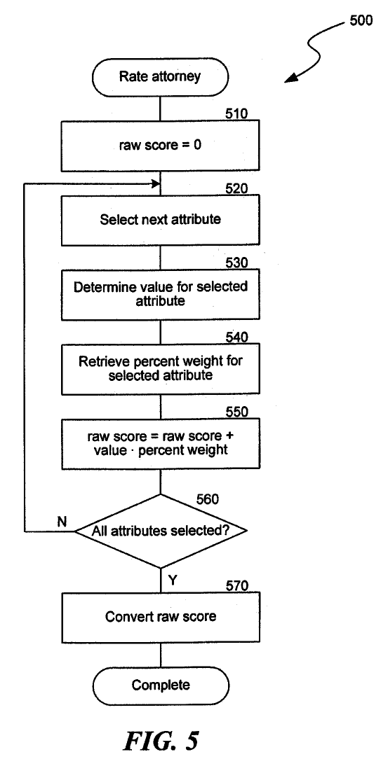

FIG. 5 is a flow diagram of a process 500 for calculating an attorney score in order to establish an attorney rating. The process is invoked when a rating for an attorney is to be calculated, which may occur automatically at predefined periods or at the prompting of a user or administrator of the system. In block 510, the rating system initializes a raw score variable to be used in calculating a rating. In this example, the initial value for the raw score is zero but an initial raw score for an attribute may take on any value. In blocks 520-560, the rating system loops through each attribute to determine the attribute's contribution to the raw score for the rating. In block 520, the rating system selects the next attribute associated with the rating. In block 530, the rating system calculates a value for the selected attribute. Calculating a value for a selected attribute may involve a simple calculation based on data associated with the attribute. For example, a value for a Years of Experience attribute may be equal to the number of years of experience. In other cases, the determination of a value may involve looking up a value in a table or computing a value based on elements for an attribute. For example, a value for a Law School attribute may be based on a third party rating system while a value for an Awards attribute may be based on current values associated for each award an attorney has received. In block 540, the rating system retrieves a percent weight for the selected attribute, which is stored in association with the rating currently being calculated. In block 550, the rating system adds the product of the value and percent weight for the selected attribute to the raw score. In decision block 560, if all attributes have not been selected, the process loops to block 520 to select the next attribute, else the process continues to block 570. In block 570, the process converts the raw score. For example, the process may compute a z-score for the rating based on the ratings of other attorneys or convert the number to a scale of 1 to 10 where 10 represents the highest rated attorney and 1 represents the attorney with the lowest rating. It will be appreciated that a raw score can be used in any manner that conveys useful information to a user of the rating system including, in some cases, displaying the raw score to the user. The processing of the rating system then completes.

From the foregoing, it will be appreciated that specific embodiments of the invention have been described herein for purposes of illustration, but that various modifications may be made without deviating from the spirit and scope of the invention. It will be appreciated that although processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Accordingly, the invention is not limited except as by the appended claims.

I/We claim:

1. A method for determining two or more ratings of an attorney in an attorney rating system, the method comprising:
identifying a plurality of attributes indicative of attorney quality;
collecting data associated with at least some of the identified plurality of attributes for an attorney from a plurality of sources; and
determining two or more ratings for the attorney by:
associating two or more of the identified plurality of attributes with each of the two or more ratings;
assigning a weight to each attribute associated with a rating; and
calculating each rating based on the attribute and the weight of each attribute, wherein each rating for the attorney is comprised of a different combination of weighted attributes.

2. The method of claim 1 wherein the plurality of attributes are selected from the set consisting of years of experience, awards, endorsements, criminal record, and sanctions.

3. The method of claim 1 wherein the plurality of sources include databases maintained by public entities.

4. The method of claim 1 wherein at least one attribute is comprised of a plurality of attribute elements, each element having an associated value.

5. The method of claim 4 wherein the value of at least one attribute element decays over time.

6. The method of claim 4 wherein the value of at least one attribute element increases over time.

7. The method of claim 1 wherein collecting data includes pulling data from a plurality of sources.

8. The method of claim 1 wherein collecting data includes receiving pushed data from a plurality of sources.

9. The method of claim 1 wherein the identified plurality of attributes associated with each rating and the weight associated with each attribute is defined by a user of the attorney rating system.

10. The method of claim 1 wherein the identified plurality of attributes associated with each rating and the weight associated with each attribute is defined by an administrator of the attorney rating system.

11. A computer-readable storage medium containing instructions for generating attorney ratings by a method comprising:
for each attorney rating,
identifying a number of attributes associated with the attorney rating,
determining a value for each attribute associated with the attorney rating,
identifying a weight for each attribute associated with the attorney rating,
calculating a raw score for the attorney rating based on the value and weight of each attribute associated with the attorney rating, and
displaying an indication of the raw score.

12. The computer-readable storage medium of claim 11 wherein the attributes are selected from the set consisting of years of experience, awards, endorsements, criminal record, and sanctions.

13. The computer-readable storage medium of claim 12 wherein the attorney ratings include an overall rating, an experience rating, an industry recognition rating, and a professional conduct rating.

14. The computer-readable storage medium of claim 13 wherein the overall rating is calculated based on a weighted combination of each of the attributes and each attribute has a non-zero weight.

15. The computer-readable storage medium of claim 13 wherein the experience rating is calculated based on a weighted combination of the years of experience attribute and the awards attribute and wherein the industry recognition rating is calculated based on a weighted combination of the awards attribute and the endorsements attribute.

16. The computer-readable storage medium of claim 11 wherein a value is determined by referencing a table mapping attribute data to values.

17. The computer-readable storage medium of claim 11 wherein at least one attribute has a plurality of associated attribute elements.

18. The computer-readable storage medium of claim 17 wherein each attribute element has an associated value and wherein a value for an attribute is based on the values associated with the elements of the attribute.

19. The computer-readable storage medium of claim 18 wherein the number of attribute elements that contribute to a value for an attribute is capped.

20. The computer-readable storage medium of claim 18 wherein the value associated with at least one attribute decays over time.

21. The computer-readable storage medium of claim 18 wherein a value for an attribute is calculated as the sum of each value associated with each element of the attribute.

22. The computer-readable storage medium of claim 11 wherein a raw score for a rating is calculated as the sum of the products of a value determined for each attribute associated with the rating and the percent weight associated with the attribute for the rating.

23. The computer-readable medium of claim 11 wherein displaying an indication of the raw score includes converting the raw score to a scale of 1 to 10.

24. The computer-readable medium of claim 11 wherein displaying an indication of the raw score includes converting the raw score to a percentage value based on a maximum value for the raw score.

25. The computer-readable medium of claim 11 wherein displaying an indication of the raw score includes converting the raw score to a value based on the ratings of other attorneys.

26. A computing system for disseminating an indication of attorney rating information, the system comprising:
a data collecting component configured to collect attorney attribute information from a plurality of sources;
a rating configuration receiving component configured to receive configuration information for a plurality of attorney ratings, the configuration information identifying one or more attributes associated with each of the plurality of attorney ratings and a weight assigned to each attribute;
a receiving component configured to receive a request for a rating of an attorney;
a ratings calculating component configured to calculate the rating for the attorney according to the weighted attributes associated with the rating; and
a sending component configured to transmit an indication of the calculated rating in response to the received request.

27. The computing system of claim 26 wherein the indication of the calculated rating is a badge for display on a website.

28. The computing system of claim 27 wherein physical attributes of the badge reflect the rating value.

29. The computing system of claim 28 wherein the physical attributes are selected from a set consisting of size, color, or font.

30. The computing system of claim 26 wherein configuration information is received from a user of the system.

31. The computing system of claim 26 wherein configuration information is received from an administrator of the system.

32. The computing system of claim 26 further comprising a valuation component configured to determine a value for an attribute.

33. The computing system of claim 32 wherein the valuation component determines a value for an attribute based on a table mapping attribute data to values.

34. The computing system of claim 32 wherein at least one attribute has as number of associated attribute elements, each element having an associated value.

35. The computing system of claim 34 wherein a value for an attribute is determined based on the values associated with the elements of the attribute.

36. The computing system of claim 26 wherein a rating is calculated at uniform intervals.

37. The computing system of claim 26 wherein a rating is calculated prior to receiving a request for the rating.

38. The computing system of claim 26 wherein a rating is calculated in response to receiving a request for the rating.
